(19) United States
(12) Patent Application Publication
(10) Pub. No.: US 2005/0047365 A1
(43) Pub. Date: Mar. 3, 2005

(54) Method for controlling a data transfer rate in a reverse link of a mobile communication system

(76) Inventors: Ki-Seob Hong, Suwon-si (KR); Sung-Kwon Jo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/928,198

(22) Filed: Aug. 30, 2004

(30) Foreign Application Priority Data
Aug. 30, 2003 (KR) 2003-60620

(51) Int. Cl. H04Q 7/00

(52) U.S. Cl. 370/328

(57) ABSTRACT

A method for controlling a Base Station (BS) to control a reverse data transfer rate in a mobile communication system includes the steps of: measuring a total user load value of a reverse link in a sector and an Rise Over Thermal (ROT) value; comparing the measured total user load value with a predetermined load threshold value, and comparing the measured ROT value with a predetermined ROT threshold value if it is determined that the measured total user load value is greater than the predetermined load threshold value; and increasing the data transfer rate if it is determined that the measured ROT value is less than or equal to the predetermined ROT threshold value.

### PRIORITY

This application claims the benefit under 35 U.S.C. 119(a) of an application entitled “METHOD FOR CONTROLLING A DATA TRANSFER RATE IN A REVERSE LINK OF A MOBILE COMMUNICATION SYSTEM”, filed in the Korean Intellectual Property Office on Aug. 30, 2003 and assigned Serial No. 2003-60620, the entire contents of which are hereby incorporated by reference.

### BACKGROUND OF THE INVENTION

1. Field of the Invention

The present invention relates to a mobile communication system. More particularly, the present invention relates to a method for controlling a data transfer rate in a reverse link.

2. Description of the Related Art

Mobile communication systems such as a Code Division Multiple Access (CDMA) system have provided users or subscribers with typically only voice services over a low-speed traffic channel. However, with the increasing development of communication technologies and the increasing demands of users or subscribers, the mobile communication system has changed significantly from a system capable of providing users with only voice services to an improved system providing users with voice services and high-speed data services.

The aforementioned mobile communication system assigns a specific traffic channel between a mobile terminal and a base station during a call control process, such that it occupies wireless channel resources. Therefore, if all the wireless channel resources capable of being assigned to a mobile terminal are currently in use, the mobile communication system is unable to perform a new call assignment process, or is also unable to enhance a data transfer rate of a previous call.

In this case, if the mobile communication system performs the new call assignment process using wireless resources greater than assignable wireless resources, or enhances the data transfer rate of the previous call using the same wireless resources, mobile terminals contained in a corresponding serving Base Station (BS) and other mobile terminals contained in a neighboring BS may be undesirably affected, such that the mobile communication system must quickly switch a corresponding call or must reduce a corresponding data transfer rate. Although the new call assignment process is not performed or the data transfer rate is not enhanced, the amount of assignable wireless resources may be changed due to the fading phenomenon, etc. Therefore, there is a need for a method for controlling the BS not only to recognize an occupation state or availability of current wireless resources, but also to determine a suitable data transfer rate.

When determining the aforementioned data transfer rate in a high-speed data service, the mobile communication system must correctly recognize an occupation state (i.e., reverse link load) of current wireless resources to determine the most suitable transfer rate without damaging the quality of an existing call (e.g., a voice call).

There are first and second methods for measuring the load of the reverse link. The first method is indicative of a load-based method for controlling a BS to measure only loads associated with a user of a sector of the BS. The second method is indicative of the Rise Over Thermal (ROT)—based method for controlling a BS to reflect all the interferences contained in a sector of the BS and an external sector in a load value. The reason why the ROT-based method reflects all the interferences in the load value is that sector resources of a mobile communication system are limited by interference caused by the users of the BS's sector and other interferences caused by the external sector.

A method for controlling a data transfer rate of a reverse link using the load-based method in a Base Station (BS) will hereinafter be described with reference to FIG. 1.

Referring to FIG. 1, the BS sums load values of all the mobile terminals contained in a sector, such that it calculates a sector load value in a reverse link at step 100. The BS compares the calculated sector load value with a predetermined threshold value at step 101. If it is determined that the calculated sector load value is less than or equal to the predetermined threshold value at step 101, the BS determines a Reverse Activity Bit (RAB) to be ‘0’ indicating that the current sector load is not in the overload state at step 102.

However, if it is determined that the calculated sector load value is greater than the predetermined threshold value at step 101, the BS determines the RAB to be ‘1’ indicating that current sector load is in the overload state at step 104. Then, the BS broadcasts the determined RAB values to all the mobile terminals contained in the sector such that the mobile terminals receive the determined RAB values at step 103.

A method for controlling a data transfer rate of a reverse link using an ROT-based method in the BS will hereinafter be described with reference to FIG. 2.

Referring to FIG. 2, the BS calculates an ROT value using total measured received power and thermal noise power (TNP) at step 200. The BS compares the calculated ROT with a predetermined threshold value at step 201. If it is determined that the ROT value is less than or equal to the threshold value at step 201, the BS determines the RAB to be ‘0’ indicating that current sector load is not in an overload state at step 202. Otherwise, if it is determined that the ROT value is greater than the threshold value at step 201, the BS determines the RAB to be ‘1’ indicating that current sector load is in the overload state at step 203. Therefore, the BS broadcasts the determined RAB values to all the mobile terminals contained in the sector such that the mobile terminals receive the determined RAB values at steps 204.

Each mobile terminal determines the data transfer rate using the RAB which is determined by either the load-based method or the ROT-based method and is then transmitted. In more detail, if the RAB is determined to be ‘0’, the mobile terminal increases the data transfer rate. If the RAB is determined to be ‘1’, the mobile terminal decreases the data transfer rate.

The aforementioned reverse load-based method can allow the amount of sector load equal to the predetermined threshold value to be accommodated in a sector of the BS, such that it has an advantage in that it can maintain a data transfer rate of a predetermined quality for a user within a limited range. However, the reverse load-based method allows the BS to measure only load associated with the user of the BS's sector, whereas it has a disadvantage in that the BS is unable to measure load caused by the external sector. Due to the aforementioned problems, a threshold value of total allowable load must be conservatively determined.

On the other hand, the aforementioned ROT-based method has an advantage in that it allows a BS to reflect the interference caused by a sector of the BS and other interferences caused by the external sector in the load. However, the ROT-based method may reduce the data transfer rate according to the environment or condition of a current serving channel.

In fact, the ROT-based method for use in the CDMA-2000 1xEV-D0 system may unexpectedly encounter a high ROT value when there is no user or there are a small number of users, due to neighboring channel interference or a narrow-band signal instantaneously appearing in a serving band. However, it can be noted that a load value measured by the load-based method in a commercial network is determined to be a very low value. Therefore, provided that the ROT-based method is used while a current system is maintained without considering the neighboring channel interference or narrow-band signal, etc., a QoS (Quality of Service) deterioration caused by the neighboring channel interference or narrow-band signal is unavoidable. Also, provided that an improved device is developed to remove the aforementioned interference, unnecessary costs and unnecessary manpower are required for the improved device.

### SUMMARY OF THE INVENTION

Therefore, the present invention has been made in view of the above problems, and it is an object of the present invention to provide a method for determining a data transfer rate of a reverse link and simultaneously removing interference by using a load-based method.

In accordance with one aspect of the present invention, the above and other objects can be accomplished by the provision of a method for controlling a Base Station (BS) to control a reverse data transfer rate in a mobile communication system. The method comprising the steps of measuring a total user load value of a reverse link in a sector and a Rise Over Thermal (ROT) value; comparing the measured total user load value with a predetermined load threshold value, and comparing the measured ROT value with a predetermined ROT threshold value if it is determined that the measured total user load value is greater than the predetermined load threshold value; and comparing the measured ROT value with a predetermined ROT threshold value if it is determined that the measured ROT value is greater than the predetermined load threshold value, and increasing the data transfer rate if it is determined that the measured ROT value is less than or equal to the predetermined ROT threshold value.

In accordance with one aspect of the present invention, there is provided a method for controlling a Base Station (BS) to control a reverse data transfer rate in a mobile communication system. The method comprising the steps of measuring a total user load value of the reverse link in a sector and the Rise Over Thermal (ROT) value; comparing the measured total user load value with a predetermined load threshold value, and calculating a sector load value using the measured ROT value if it is determined that the measured total user load value is greater than the predetermined load threshold value; calculating load values of the remaining users other than a user who desires to determine the data transfer rate, and determining a load value of the user who desires to determine the date transfer rate to be the minimum data transfer rate; adding a new load value determined to be the minimum data transfer rate to the load values of the remaining users to calculate a new sector load value, and comparing the new sector load value with a predetermined load threshold value; and comparing the data transfer rate of a user with the predetermined minimum data transfer rate if it is determined that the new sector load value is greater than the predetermined threshold value, and determining the data transfer rate to reduce the data transfer rate of the user if it is determined that the data transfer rate of the user is greater than the minimum data transfer rate.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flow chart illustrating a conventional method for controlling a Base Station (BS) to determine the presence or absence of the reverse link overload using a load-based method;

FIG. 2 is a flow chart illustrating a conventional method for controlling a BS to determine the presence or absence of a reverse link overload using an Rise Over Thermal (ROT)-based method;

FIG. 3 is a flow chart illustrating a method for controlling a BS to determine the presence or absence of a reverse link overload in accordance with an embodiment of the present invention; and

FIGS. 4A-4B are flow charts illustrating a method for controlling a BS to determine a data transfer rate of a mobile terminal in accordance with an embodiment of the present invention.

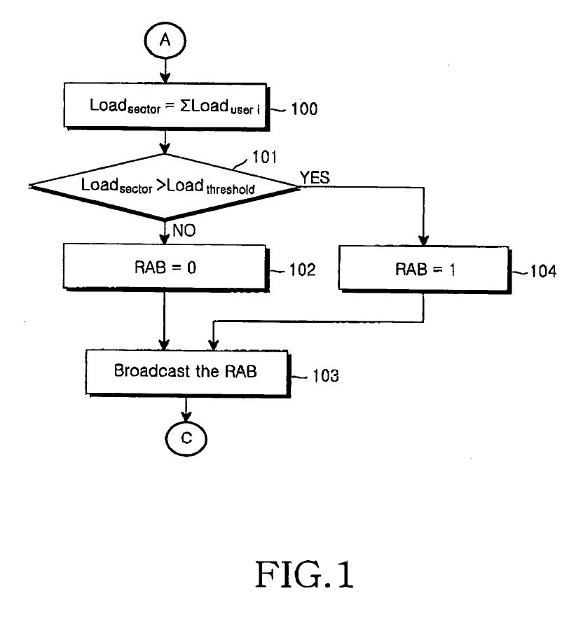

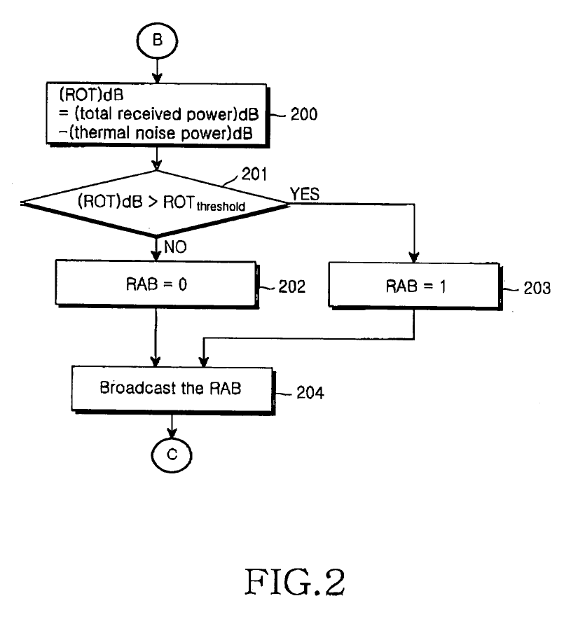

### DETAILED DESCRIPTION OF THE PREFERRED EMBODIMENTS

Embodiments of the present invention will now be described in detail with reference to the accompanying drawings. In the drawings, the same or similar elements are denoted by the same reference numerals even though they are depicted in different drawings. In the following description, a detailed description of known functions and configurations incorporated herein will be omitted for conciseness.

An embodiment of the present invention calculates a load value on the basis of an Rise Over Thermal (ROT) value determined by received power and thermal noise power, a reference channel received from a channel card, and a data transfer rate, compares the load value with a predetermined reference threshold value, and selects one of a load-based method and an ROT-based method, such that it can determine the presence or absence of a reverse link overload or an assignable data transfer rate using the selected method.

Also, an embodiment of the present invention controls a data transfer rate of a reverse link using load caused by a user of a sector of a BS, and also controls a data transfer rate of a reverse link using an ROT including all the interferences in other ranges other than the BS sector.

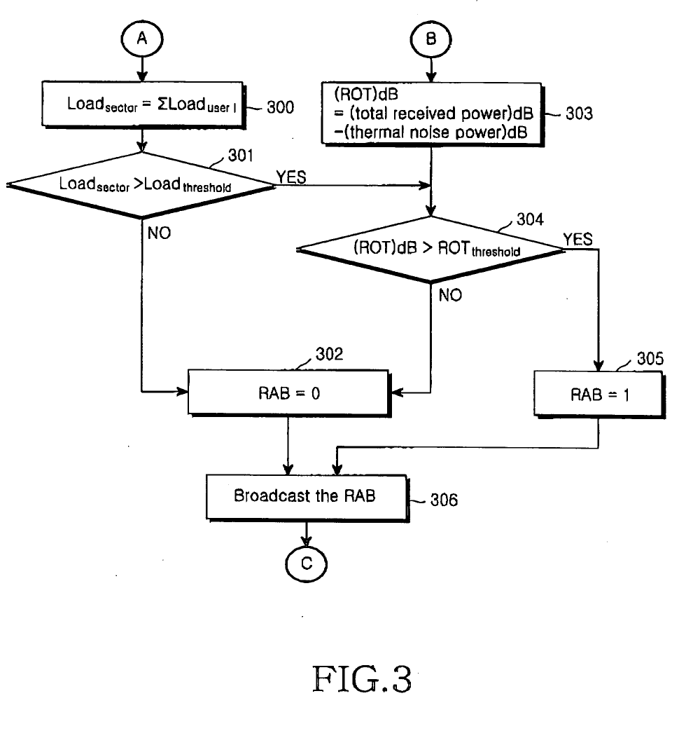

FIG. 3 is a flow chart illustrating a load control method of a reverse link in accordance with an embodiment of the present invention.

Referring to FIG. 3, the Base Station (BS) calculates a sector load value on the basis of a pilot channel serving as a reference channel for each user and a data transfer rate at step 300, and calculates a ROT value using the measured received power and thermal noise power at step 303. The BS compares the calculated sector load value with a predetermined load threshold value at step 301.

If it is determined that the calculated sector load value is less than or equal to the predetermined load threshold value at step 301, the BS determines the RAB to be ‘0’ indicating that a reverse link is not in an overload state at step 302.

Otherwise, if it is determined that the sector load value is greater than the predetermined load threshold value at step 301, the BS compares the measured ROT value of the above step 303 with a predetermined ROT threshold value at step 304. If it is determined that the ROT value is less than or equal to the predetermined ROT threshold value at step 304, the BS determines the RAB to be ‘0’ indicating that a reverse link is not in the overload state at step 302.

If it is determined that the ROT value is less than the predetermined ROT threshold value at step 304, the BS determines the RAB to be ‘1’ indicating that a reverse link is in the overload state at step 305. Therefore, the BS broadcasts the determined RAB values of steps 302 and 305 for all the mobile terminals contained in the sector such that the mobile terminals can receive the determined RAB values at steps 306.

Although the following operations of the mobile terminal are not shown in the drawings, it should be noted that the mobile terminal receives the broadcast RAB value, increases a data transfer rate of a reverse link when the received broadcast RAB value is determined to be ‘0’, and reduces a data transfer rate of a reverse link when the received broadcast RAB value is determined to be ‘1’.

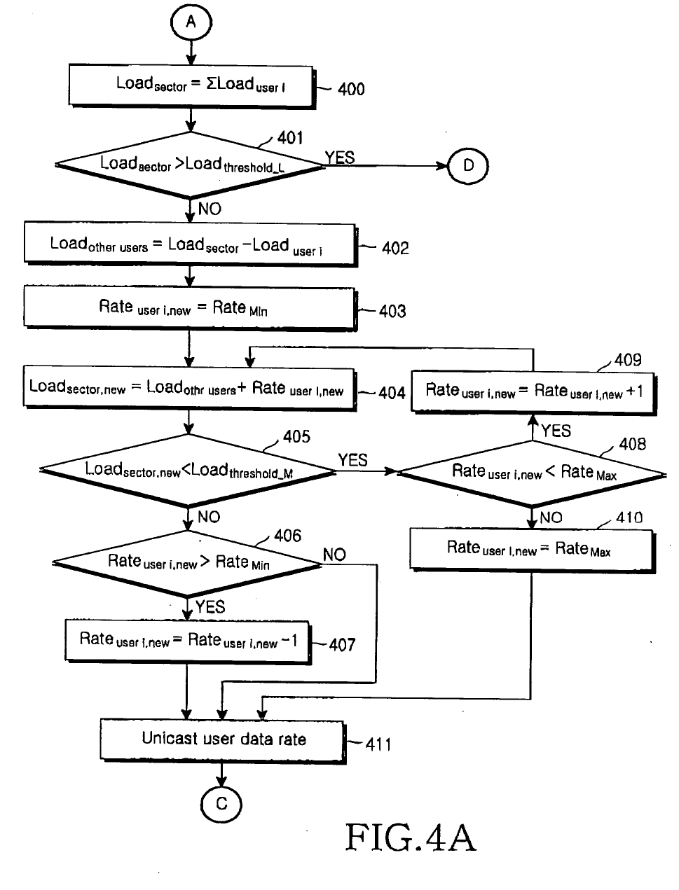

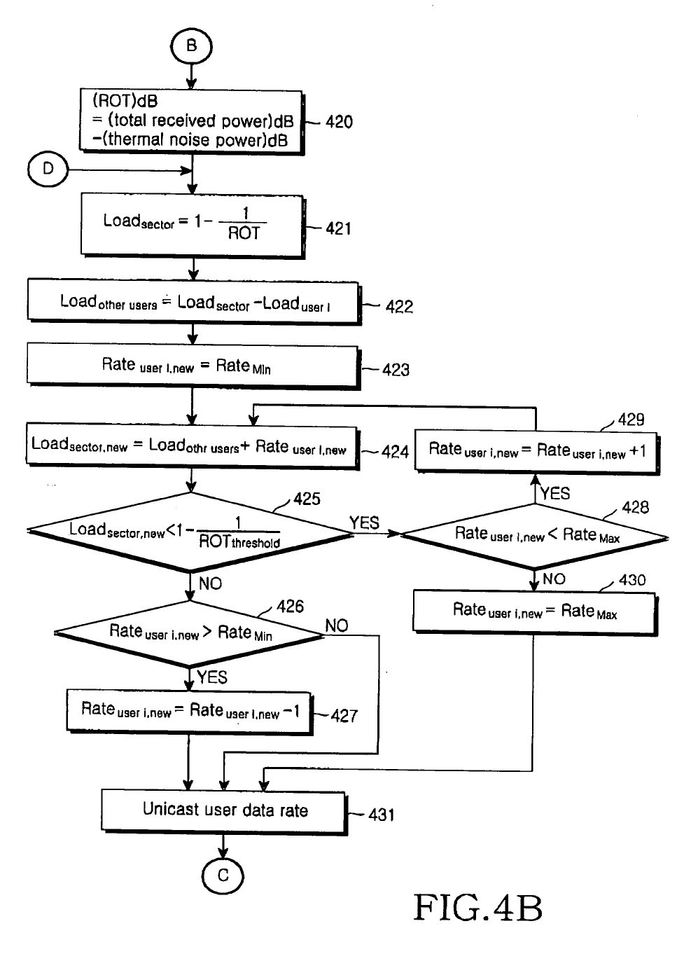

The aforementioned description has disclosed an embodiment of the present invention in which the mobile terminal determines a reverse data transfer rate using the RAB value. The following description will disclose another embodiment of the present invention in which the BS determines a data transfer rate of the mobile terminal with reference to FIGS. 4A-4B.

Referring to FIGS. 4A-4B, the BS calculates a sector load value on the basis of a pilot channel serving as a reference channel for each user and a data transfer rate at step 400, and calculates an ROT value using the measured received power and thermal noise power at step 420.

The BS compares the calculated sector load value with a predetermined threshold sector load value at step 401. If it is determined that the calculated sector load value is the same or less than the predetermined threshold sector load value at step 401, the BS calculates load values of the remaining users other than a user who desires to determine the data transfer rate at step 402. Specifically, the BS subtracts the data transfer rate of the user who desires to determine the data transfer rate from the sector load value calculated at the above step 400 at step 402. The BS determines a load value of the user who desires to determine the data transfer rate to be a minimum data transfer rate at step 403. The BS adds the minimum data transfer rate of the above step 403 to load values of other users at step 404, such that it can calculate a new sector load value.

The BS compares the new sector load of the above step 404 with a predetermined load threshold value at step 405. The relationship among threshold value of the step 405, the threshold value of the step 401, and the threshold value to be used at step 425 can be represented by the following equation 1:
Load_{threshold-L}≦Load_{threshold-M}≦1−1/ROT_{threshold} Equation 1

If it is determined that the sector load value is greater than or equal to the load threshold value at step 405, the BS compares the data transfer rate of a user with a predetermined minimum data transfer rate at step 406. If it is determined that the data transfer rate of the user is greater than the predetermined minimum data transfer rate at step 406, the BS reduces the data transfer rate of the user at step 407. Otherwise, if it is determined that the data transfer rate of the user is less than or equal to the predetermined minimum data transfer rate at step 406, the BS goes to step 411.

If it is determined that the sector load value is the same or less than the threshold value at step 405, the BS compares the data transfer rate of the user with a maximum data transfer rate at step 408. If it is determined that the data transfer rate of the user is less than the maximum data transfer rate at step 408, the BS increases the data transfer rate of the user at step 409, and goes to step 404. However, if it is determined that the data transfer rate of the user is greater than or equal to the maximum data transfer rate at step 408, the BS determines the data transfer rate of the user to be a maximum value at step 410. The BS transmits the determined data transfer rate to a specific mobile terminal according to a unicast scheme at step 411.

In the meantime, if the sector load value is less than the minimum load threshold value at step 401, the BS goes to step 421 of FIG. 4B to determine the data transfer rate of the reverse link according to the ROT-based method. The BS calculates a sector load value using an ROT value calculated at step 420 and the following equation 2:
Load_{sector}=1−1/ROT Equation 2

The BS calculates load values of the remaining users other than a user who desires to determine the data transfer rate at step 422. Specifically, the BS subtracts a load value of a user who desires to determine the data transfer rate from the sector load value of step 421 at step 422. The BS determines a load value of the user who desires to determine the data transfer rate to be the minimum data transfer rate at step 423. The BS adds the minimum data transfer rate of step 423 to the load values of other users at step 424, such that it can acquire a new sector load value.

The BS compares the new sector load value of step 424 with the predetermined load threshold value at step 425. In this case, the predetermined load threshold value can be denoted by the following equation 3:
Load_{threshold}=1−1/ROT_{threshold} Equation 3

If it is determined that the new sector load value is greater than or equal to the threshold value at step 425, the BS compares the data transfer rate of the user with the predetermined minimum data transfer rate at step 426. If it is determined that the data transfer rate of the user is greater than the predetermined minimum data transfer rate at step 426, the BS reduces the data transfer rate of the user at step 427. Otherwise, if it is determined that the data transfer rate of the user is less than or equal to the predetermined minimum data transfer rate at step 426, the BS goes to step 431.

If it is determined that the sector load value is less than the threshold value at step 425, the BS compares the data transfer rate of the user with a maximum data transfer rate at step 428. If it is determined that the data transfer rate of the user is less than the maximum data transfer rate at step 428, the BS increases the data transfer rate of the user at step 429, and goes to step 424. However, if it is determined that the data transfer rate of the user is greater than or equal to the maximum data transfer rate at step 428, the BS determines the data transfer rate of the user to be a maximum value at step 430. The BS transmits the determined data transfer rate of steps 427 and 430 to a specific mobile terminal according to a unicast scheme at step 431.

As apparent from the above description, the embodiments of the present invention use both an advantage of the load-based method and an advantage of the ROT-based method without changing a hardware design of a conventional system, such that it increases data service quality, system stability, and system performance.

Although the embodiments of the present invention have been disclosed for illustrative purposes, those skilled in the art will appreciate that various modifications, additions and substitutions are possible, without departing from the scope and spirit of the invention as disclosed in the accompanying claims.

1. A method for controlling a Base Station (BS) to control a reverse data transfer rate in a mobile communication system, comprising the steps of:
measuring a total user load value of a reverse link in a sector and an Rise Over Thermal (ROT) value;
comparing the measured total user load value with a predetermined load threshold value, and comparing the measured ROT value with a predetermined ROT threshold value if it is determined that the measured total user load value is greater than the predetermined load threshold value; and
comparing the measured ROT value with the predetermined ROT threshold value if it is determined that the measured ROT value is greater than the predetermined load threshold value, and increasing a data transfer rate if it is determined that the measured ROT value is less than or equal to the predetermined ROT threshold value.

2. The method according to claim 1, further comprising the step of:
reducing the data transfer rate, if the measured ROT value is greater than the predetermined ROT threshold value according to the comparison result between the measured ROT value and the predetermined ROT threshold value.

3. The method according to claim 1, further comprising the step of:
increasing the data transfer rate, if the measured total user load value is less than or equal to the predetermined load threshold value according to the comparison result between the measured total user load value and the predetermined load threshold value.

4. A method for controlling a Base Station (BS) to control a reverse data transfer rate in a mobile communication system, comprising the steps of:
measuring a total user load value of a reverse link in a sector and an Rise Over Thermal (ROT) value;
comparing the measured total user load value with a predetermined load threshold value, and calculating the sector load value using the measured ROT value if it is determined that the measured total user load value is greater than the predetermined load threshold value;
calculating load values of the remaining users other than a user who desires to determine a data transfer rate, and determining a load value of the user who desires to determine the date transfer rate to be a minimum data transfer rate;
adding a new load value determined to be the minimum data transfer rate to the load values of the remaining users to calculate a new sector load value, and comparing the new sector load value with a predetermined load threshold value; and
comparing the data transfer rate of a user with the predetermined minimum data transfer rate if it is determined that the new sector load value is greater than or equal to the predetermined load threshold value, and determining the data transfer rate to reduce the data transfer rate of the user if it is determined that the data transfer rate of the user is greater than the minimum data transfer rate.

5. The method according to claim 4, further comprising the step of:
comparing the data transfer rate of the user with a maximum data transfer rate if it is determined that the new sector load value is less than the predetermined load threshold value, and increasing the data transfer rate if it is determined that the data transfer rate of the user is less than the maximum data transfer rate.

6. The method according to claim 5, further comprising the step of:
comparing the data transfer rate of the user with the maximum data transfer rate if it is determined that the new sector load value is less than the predetermined load threshold value, and determining the data transfer rate to be the maximum data transfer rate if it is determined that the data transfer rate of the user is greater than or equal to the maximum data transfer rate.

7. The method according to claim 4, wherein the step of comparing the measured total user value with the predetermined load threshold value includes the steps of:
calculating the load values of the remaining users other than a user who desires to determine a data transfer rate if it is determined that the measured total user load value is less than or equal to the predetermined load threshold value, and determining a load value of the user who desires to determine the data transfer rate to be a minimum data transfer rate;
adding the minimum data transfer rate to the load values of the remaining users, thereby calculating a new sector load value;
comparing the new sector load value with the predetermined load threshold value, and comparing the data transfer rate of the user with a predetermined minimum data transfer rate if it is determined that the new sector load value is greater than or equal to the predetermined load threshold value; and
reducing the data transfer rate of a user if it is determined that the data transfer rate of the user is greater than the predetermined minimum transfer rate.

8. The method according to claim 7, wherein the step of comparing the new sector load value with the predetermined load threshold value includes the steps of:
comparing the data transfer rate of the user with the maximum data transfer rate if it is determined that the new sector load value is less than the predetermined load threshold value; and
increasing the data transfer rate if it is determined that the data transfer rate of the user is less than the maximum data transfer rate.

9. The method according to claim 7, wherein the step of comparing the data transfer rate of the user with the maximum data transfer rate includes the step of:
determining the data transfer rate of the user to be a maximum data transfer rate if it is determined that the data transfer rate of the user is greater than or equal to the maximum data transfer rate.
